(19) United States
(12) Patent Application Publication
(10) Pub. No.: US 2006/0112184 A1
(43) Pub. Date: May 25, 2006

(54) Adapter card for on-demand formatting of data transfers between network devices

(75) Inventor: Lih-Chung Kuo, San Jose, CA (US)

Correspondence Address: Frank C. Nicholas;CARDINAL LAW GROUP, Suite 2000, 1603 Orrington Avenue, Evanston, IL, 60201, US

(73) Assignee: International Business Machines Corporation, Armonk, NY (US)

(21) Appl. No.: 10/994,856

(22) Filed: Nov. 22, 2004

(51) Int. Cl. G06F 15/16

(52) U.S. Cl. 709/236

(57) ABSTRACT

An adapter card employs a multi-formatting execution unit, one or more descriptor queues and one or more communication channels. The multi-formatting execution unit formats each data transfer between two or more network devices based on one of a plurality of data formatting schemes with each data formatting scheme being at least partially dissimilar from the other data formatting schemes. The descriptor queue(s) store one or more job descriptors with each job descriptor being indicative of a selection of one of the data formatting schemes for formatting a corresponding data transfer between the network devices. The communication channels operable to selectively connect the descriptor queue(s) to the multi-formatting execution unit to facilitate an electrical communication of each one job descriptor from the descriptor queue(s) to the multi-formatting execution unit.

### FIELD OF INVENTION

The present invention generally relates to formatting of data during a data transfer between two or more network devices (e.g., a host computer and a disk drive, a host computer and a tape drive, and a pair of disk drives). The present invention specifically relates to allocating and partitioning storage controller resources, on-demand, to concurrently perform various data formatting schemes (e.g., a Direct Access Storage Device (“DASD”) formatting scheme, Tape formatting scheme, and a Peer to Peer Remote Copy (“PPRC”) formatting scheme).

### BACKGROUND OF THE INVENTION

Historically, different adapter cards have been developed to perform DASD formatting schemes and Tape formatting schemes. For example, FIG. 1 illustrates a DASD execution unit 31 and a First-In-First-Out queue (“FIFO”) 32 of a DASD formatter 30, which is typically installed as an Application Specific Integrated Circuit (“ASIC”) chip on a DASD adapter card. In operation, FIFO queue 32 sequentially lists formatting jobs 33(1)-33(M), where M≧1, of data associated with requested data transfers in the form of data read cycles (“DRC”) 22 between host computer 20 and disk drive 21 and/or data write cycles (“DWC”) 23 between host computer 20 and disk drive 21. DASD execution unit 31 implements a DASD formatting scheme to facilitate an execution of the data formatting jobs as listed in FIFO queue 32. Various DASD formatting schemes that can be performed by DASD execution unit 31 typically include Cyclical Redundancy Checking (“CRC”), byte alignment, compression/decompression, field CRC, and Longitudinal Redundancy Checking (“LRC”).

Also by example, FIG. 2 illustrates a Tape execution unit 41 and a First-In-First-Out queue (“FIFO”) 42 of a Tape formatter 40, which is typically installed as an ASIC chip on a Tape adapter card. In operation, FIFO queue 42 sequentially list formatting jobs 43(1)-43(N), where N≧1, of data associated with requested data transfers in the form of data read cycles (“DRC”) 25 between host computer 20 and tape drive 24 and/or data write cycles (“DWC”) 26 between host computer 20 and tape drive 24. Tape execution unit 41 implements a Tape formatting scheme to facilitate an execution of the formatting jobs as listed in FIFO queue 42. Various Tape formatting schemes that can be performed by Tape execution unit 41 typically include CRC, and byte alignment, compression/decompression, and CRC.

In some cases, both DASD execution unit 31 (FIG. 1) and Tape execution unit 41 (FIG. 2) have been formed on the same ASIC chip. However, the DASD execution unit 31 remains operable and the Tape execution unit 41 is rendered inoperable when such an ASIC chip is placed on a DASD adapter card. Conversely, the DASD execution unit 31 is rendered inoperable and the Tape execution unit 41 remains operable when such an ASIC chip is placed on a Tape adapter card. Either way does not support a concurrent performance of a DASD formatting scheme and a Tape formatting scheme on one adapter card.

### SUMMARY OF THE INVENTION

The present invention provides a new and unique adapter card for enabling a concurrent performance of various data formatting schemes including, but not limited to, DASD formatting schemes, Tape formatting schemes, and PPRC formatting schemes.

One form of an adapter card of the present invention employs a multi-formatting execution unit, one or more descriptor queues and one or more communication channels. The multi-formatting execution unit formats each data transfer between two or more network devices based on one of a plurality of data formatting schemes with each data formatting scheme being at least partially dissimilar from the other data formatting schemes. The descriptor queue(s) store one or more job descriptors with each job descriptor being indicative of a selection of one of the data formatting schemes for formatting a corresponding data transfer between the network devices. The communication channel(s) selectively connect the descriptor queue(s) to the multi-formatting execution unit to facilitate an electrical communication of each job descriptor from the descriptor queue(s) to the multi-formatting execution unit.

A second form of an adapter card of the present invention employs a formatter, one or more card processors, and one or more buffer memories. The formatter formats each data transfer between two or more network devices as a function of one or more job descriptors with each job descriptor being indicative of a selection of one of a plurality of data formatting schemes for formatting a corresponding data transfer between the network devices, with data formatting scheme being at least partially dissimilar from the other data formatting schemes. The buffer memory(ies) are coupled to the card processor(s) wherein the buffer memory(ies) store instructions operable with the card processor(s) to perform operations including (1) a generation of the job descriptor(s) in response to an electrical communication of one or more data transfer commands from the network device(s) with each data transfer command requesting a particular data transfer between at least two network devices be formatted based on one of the plurality of data formatting schemes, (2) a management of a storage of one or more of job descriptor (s) in the card buffer memory (ies), and (3) a management of a storage of an address pointer in the formatter for each job descriptor stored in the card buffer memory(ies). Alternatively, the buffer memory(ies) are coupled to the card processor(s) wherein the buffer memory(ies) store instructions operable with the card processors to perform operations including (1) a generation of the job descriptor(s) in response to an electrical communication of one or more data transfer commands from the at least two network devices with each data transfer command requesting a particular data transfer between the at least two network devices be formatted based on one of the plurality of data formatting schemes, and (2) a management of a storage of one or more of job descriptor (s) in the formatter.

The forgoing forms and other forms, features and advantages as well as features and advantages of the present invention will become further apparent from the following detailed description of the presently preferred embodiments, read in conjunction with the accompanying drawings. The detailed description and drawings are merely illustrative of the present invention rather than limiting with the scope of the present invention being defined by the appended claims and equivalents thereof.

### BRIEF DESCRIPTION OF THE DRAWINGS

FIG. 1 illustrates an exemplary DASD formatter as known in the art;

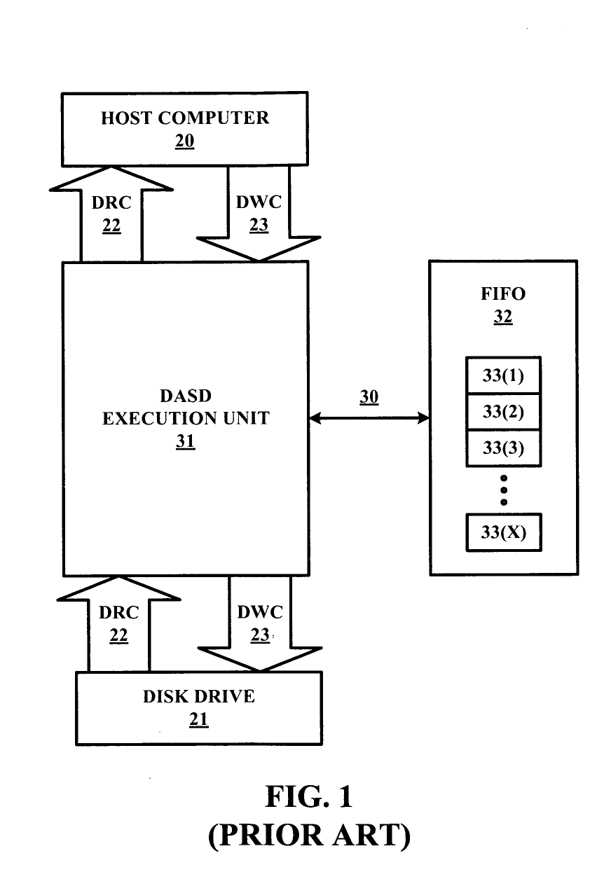

FIG. 2 illustrates an exemplary Tape formatter as known in the art;

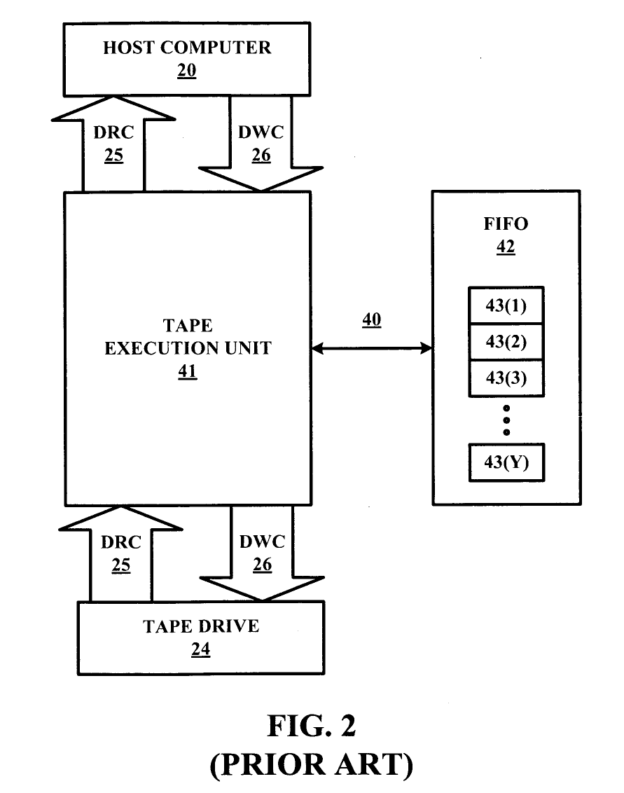

FIG. 3 illustrates one exemplary embodiment of an On-Demand formatter in accordance with the present invention;

FIG. 4 illustrates one exemplary embodiment in accordance with the present invention of the On-Demand formatter illustrated in FIG. 3;

FIG. 5 illustrates an exemplary operation of the On-Demand formatter illustrated in FIG. 4;

FIG. 6 illustrates one exemplary embodiment in accordance with the present invention of a multi-formatting execution unit as illustrated in FIG. 4;

FIG. 7 illustrates a first exemplary embodiment in accordance with the present invention of a descriptor queue as illustrated in FIG. 4;

FIG. 8 illustrates one exemplary embodiment in accordance with the present invention of a job descriptor as illustrated in FIG. 5;

FIG. 9 illustrates a second exemplary embodiment in accordance with the present invention of a descriptor queue as illustrated in FIG. 4;

FIG. 10 illustrates one exemplary embodiment of an On-Demand adapter card in accordance with the present invention;

FIG. 11 illustrates an exemplary write operation of the On-Demand adapter card illustrated in FIG. 10;

FIG. 12 illustrates an exemplary read operation of the On-Demand adapter card illustrated in FIG. 10; and

FIG. 13 illustrates one exemplary embodiment of a computer and storage system in accordance with the present invention.

### DESCRIPTION OF THE PRESENT INVENTION

A job descriptor of the present invention is digital information indicative of a particular data formatting scheme among a plurality of data formatting schemes for a corresponding data transfer between two or more network devices. For purposes of the present invention, a “data formatting scheme” encompasses various techniques for managing a physical transfer of data between two or more network devices such as, for example, data compression/decompression techniques, error checking techniques and validity checking techniques. The generation of ajob descriptor is particularly suited for an on-demand storage or an on-demand retrieval of data from one of a variety of storage devices (e.g., a disk drive or a tape drive).

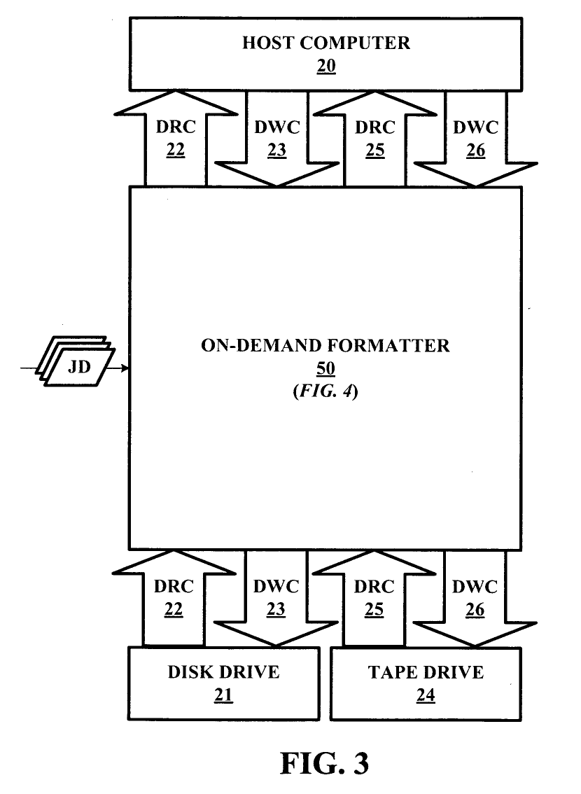

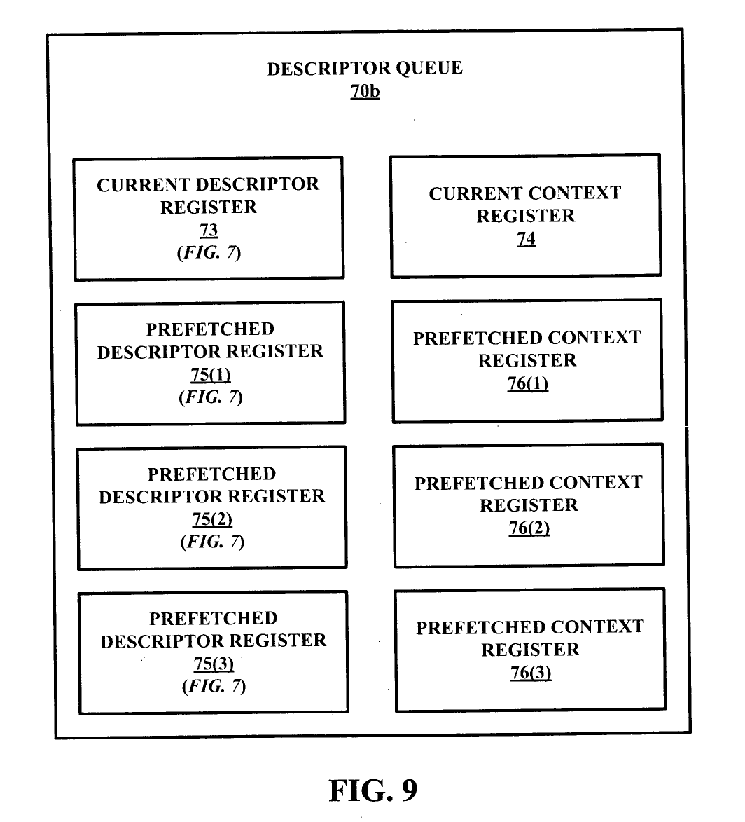

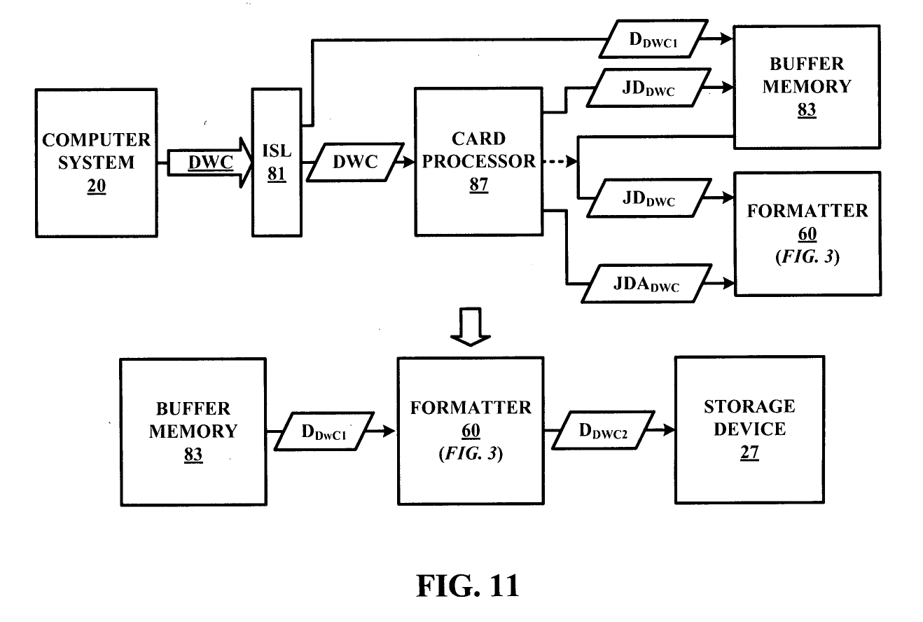

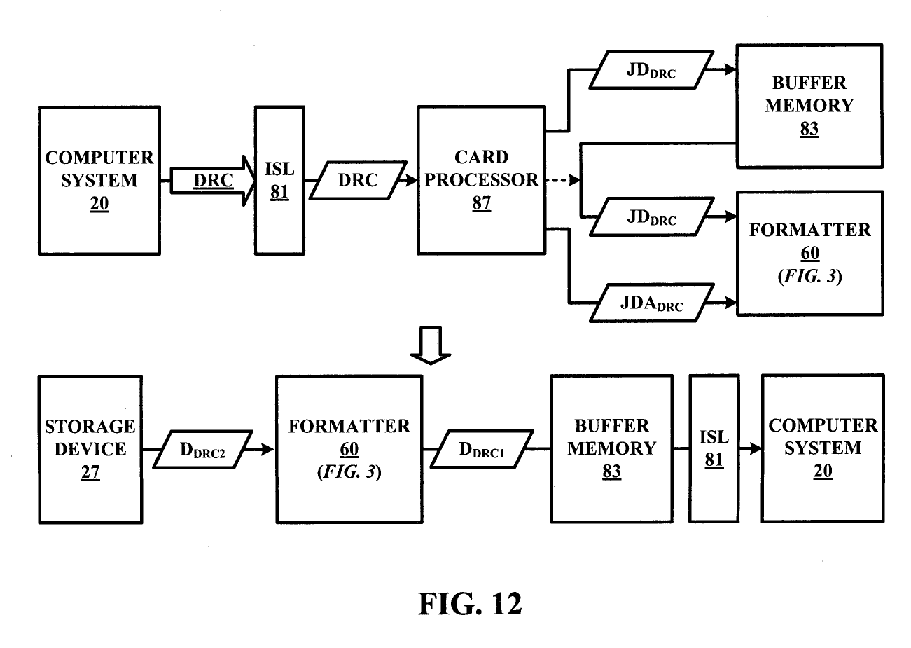

To facilitate an understanding of the present invention by those having ordinary skill in the art, new and unique structural configurations of an on-demand formatter to be installed on an adapter card for formatting data transfers between network devices as a function of job descriptors will now be described herein in the context of the on-demand formatter being configured to selectively implement a DASD formatting scheme or a Tape formatting scheme based on the job descriptors. Specifically, FIGS. 3-8 illustrate an exemplary on-demand DASD/tape formatter, FIGS. 9-11 illustrate an exemplary incorporation of the on-demand DADS/tape formatter on an adapter card, and FIG. 12 illustrates an exemplary incorporation of the adapter card in a computer and storage system having disk drives and tape drives. From the description of FIGS. 3-12, those having ordinary skill in the art will appreciate the numerous and wide-ranging structural configurations available for an on-demand formatter and adapter card for selectively implementing two or more data formatting schemes in accordance with the principles of the present invention.

FIG. 3 illustrates an on-demand DASD/tape formatter 50 receiving a plurality of job descriptors JD communicated to formatter 50 from an external source (e.g., an adapter card processor and/or an adapter card buffer memory). Formatter 50 includes hardware, software and/or firmware structurally configured for formatting data read cycles DRC 22 and data write cycles DWC 23 between computer system 20 and disk drive 21 in response to each job descriptor JD that is indicative of a DASD formatting scheme including, but not limited to, CRC (e.g., global CRC based on data from a host computer and field CRC based on receiving network device), byte alignment, compression/decompression, and LRC. Formatter 50 also includes hardware, software and/or firmware structurally configured for formatting data read cycles DRC 25 and data write cycles DWC 26 between computer system 20 and a tape drive 24 in response to each job descriptor JD indicative of a Tape formatting scheme including, but not limited to, Global CRC, byte alignment, compression/decompression, and Blythe CRC.

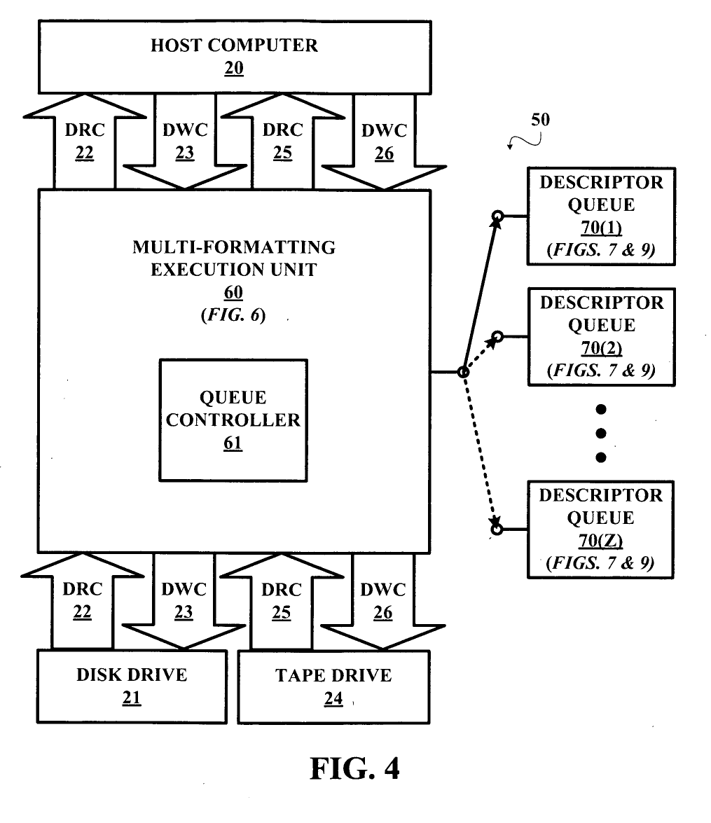

In practice, the structural configuration of formatter 50 will be dependent upon the specification of an adapter card upon which formatter 50 will be installed. FIG. 4 illustrates one structural configuration of formatter 50 employing a multi-formatting execution unit 60 and a Z number of descriptor queues 70, where Z≧1.

Multi-formatting execution unit 60 includes hardware, software and/or firmware structurally configured for executing job descriptors indicative of a DASD formatting scheme corresponding to data read cycles DRC 22 and data write cycles DWC 23 between computer system 20 and disk drive 21. Multi-formatting execution unit 60 further includes hardware, software and/or firmware structurally configured for executing job descriptors indicative of a Tape formatting scheme corresponding to data read cycles DRC 25 and data write cycles DWC 26 between computer system 20 and tape drive 21.

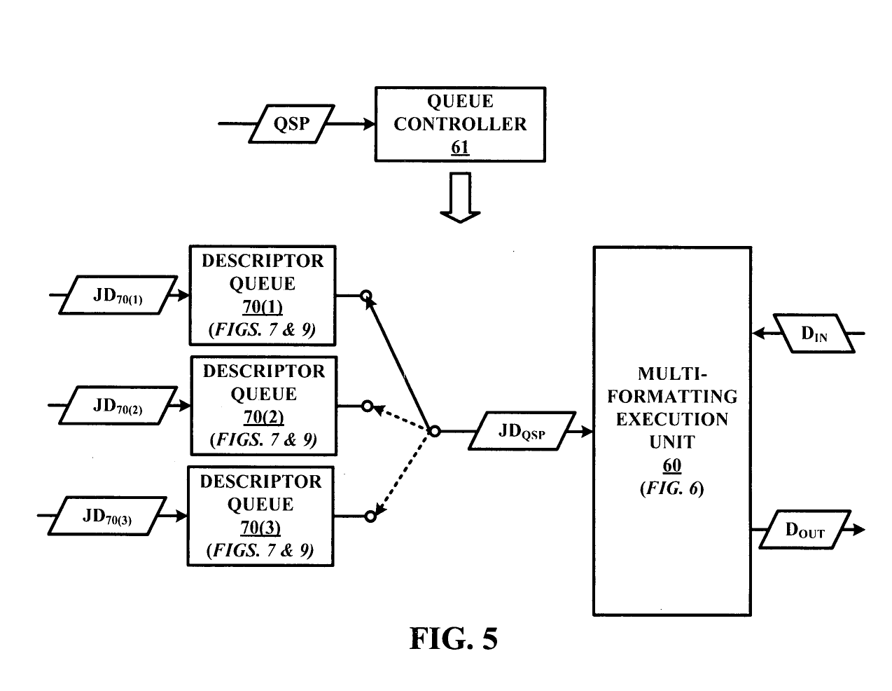

Each descriptor queue 70 includes hardware, software and/or firmware structurally configured for storing the job descriptor(s) whereby each job descriptor is communicated to multi-formatting execution unit 60 in a predetermined manner. For embodiments having only one descriptor queue 70 (i.e., Z=1), multi-formatting execution unit 60 can be permanently coupled to the single descriptor queue 70 or temporary connections can be established by a queue controller 61 between multi-formatting execution unit 60 and the single descriptor queue 70. For embodiments having a plurality of descriptor queues 70 (i.e., Z≧2), queue controller 61 controls a switched network of one of more communication channels coupling the descriptor queue(s) 70 to multi-formatting execution unit 60, the switched network of communication channels being symbolically illustrated as a single throw multi-pole switch in FIGS. 4 and 5. In any case, queue controller 61 includes hardware, software and/or firmware structurally configured to control a communication of the job descriptors to multi-formatting execution unit 60 in accordance with a queue swap policy programmed into queue controller 61. The queue swap policy is representative of a queue swapping among descriptor queues 70 that involves a selective connection of one of the descriptor queues 70 to multi-formatting execution unit 60 while the remaining descriptor queues 70 are disconnected from multi-formatting execution unit 60.

To facilitate an understanding of queue controller 61, FIG. 5 illustrates an exemplary operation of three (3) descriptor queues 70 in accordance with queue swap policy QSP programmed into queue controller 61. In this example, the queue swap policy sets forth a multiplexing connecting/disconnecting of the three (3) descriptor queues 70 based on the contents of three (3) descriptor queues 70. As illustrated in FIG. 5, descriptor queue 70(1) stores a job descriptor JD₇₀₍₁₎, descriptor queue 70(2) stores a job descriptor JD₇₀₍₂₎ and descriptor queue 70(3) stores a job descriptor JD₇₀₍₃₎. In accordance with queue swap policy QSP, queue controller 61 connects the communication channel between multi-formatting execution unit 60 and descriptor queue 70(1) while disconnecting the communication channels between multi-formatting execution unit 60 and descriptor queues 70(2) and 70(3) to thereby allow a communication of job descriptor JD₇₀₍₁₎ in the form of a job descriptor JD_{QSP} from descriptor queue 70(1) to multi-formatting execution unit 60, which formats incoming data DIN in accordance with the data formatting scheme indicated by job descriptor JD_{QSP} to render formatted outgoing data D_{OUT}.

Thereafter, queue controller 61 connects the communication channel between multi-formatting execution unit 60 and descriptor queue 70(2) while disconnecting the communication channels between multi-formatting execution unit 60 and descriptor queues 70(1) and 70(3) to thereby allow a communication of job descriptor JD₇₀₍₂₎ in the form of a job descriptor JD_{QSP} from descriptor queue 70(2) to multi-formatting execution unit 60, which formats incoming data DIN in accordance with the data formatting scheme indicated by job descriptor JD_{QSP} to render formatted outgoing data D_{OUT}.

Finally, queue controller 61 connects the communication channel between multi-formatting execution unit 60 and descriptor queue 70(3) while disconnecting the communication channels between multi-formatting execution unit 60 and descriptor queues 70(1) and 70(2) to thereby allow a communication of job descriptor JD₇₀₍₃₎ in the form of a job descriptor JD_{QSP} from descriptor queue 70(3) to multi-formatting execution unit 60, which formats incoming data DIN in accordance with the data formatting scheme indicated by job descriptor JD_{QSP} to render formatted outgoing data D_{OUT}.

From these example, those having ordinary skill in the art will appreciate the wide-ranging complexity of a queue swap policy from a simple policy for a single queue descriptor 70 to a medium complexity policy for a plurality of queue descriptors 70 based on the content of the queue descriptors 70 to a high complexity policy for a plurality of queue descriptors 70 based on numerous factors (e.g., content, time, and a chaining of job descriptors). Those skilled in the art will also appreciate that, in practice, the structural configuration of unit 60, queues 70 and the communication channels will be dependent upon the specification of an adapter card upon which formatter 50 will be installed.

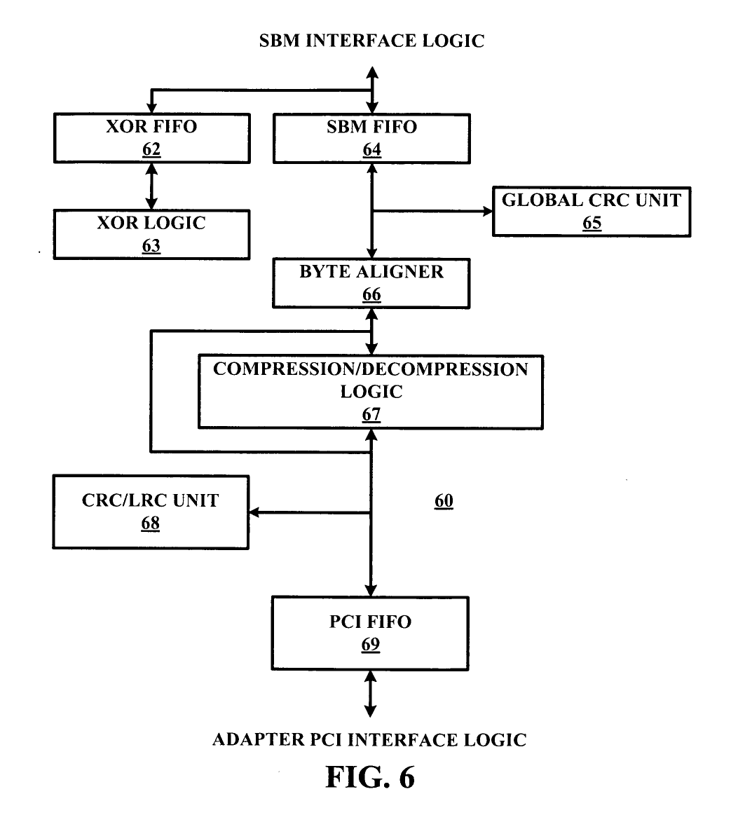

FIG. 6 illustrates an exemplary structural configuration of multi-formatting execution unit 60 employing an XOR FIFO 62, an XOR logic circuit 63, a SBM FIFO 64, a global CRC unit 65, a byte aligner 66, a compression/decompression logic circuit 67, a CRC/LRC unit 68, and a PCI FIFO 69. Components 65-67 can be enabled in both an implementation of a DASD formatting scheme and a Tape formatting scheme. CRC/LRC unit 68 can be enabled to provide a field CRC and a LRC for the DASD formatting scheme, and enabled to provide a Blythe CRC for the Tape formatting scheme. Circuit 63 is used to implement a supplemental XOR function. A job descriptor being currently executed by unit 60 will indicate which components to enable and/or how to enable them, or whether to perform an XOR function on the data.

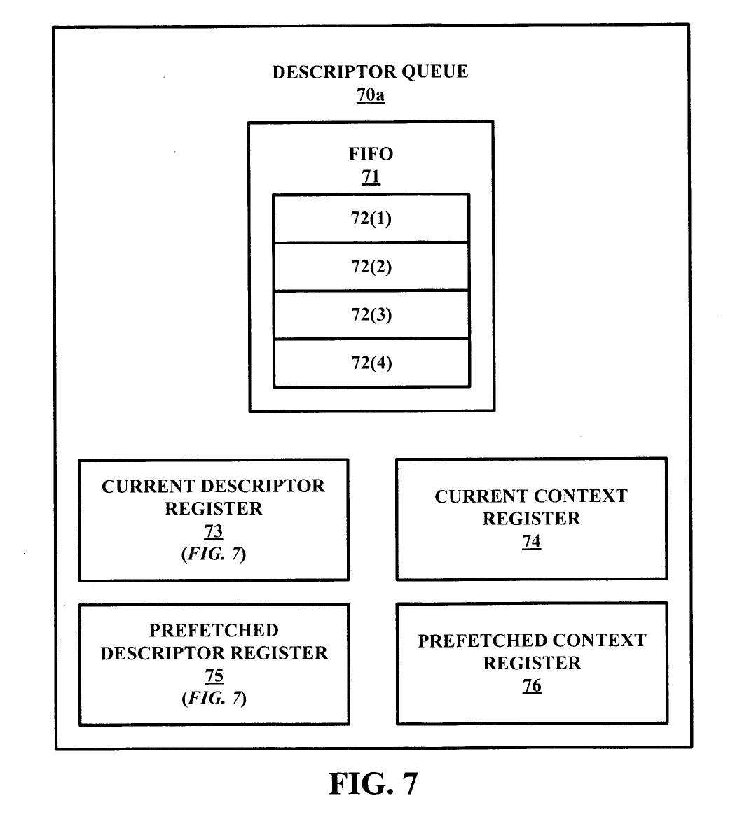

FIG. 7 illustrate an exemplary embodiment of descriptor queue 70 employing a four (4) word FIFO queue 71, a current job descriptor register 73, a current context register 74, a prefetched job descriptor register 75, and a prefetched context register 76. FIFO queue 71 stores an address location 72(1)-72(4) for up to four job descriptors. If an address is currently being stored in address location 72(1) of FIFO queue 71, then register 73 stores a job descriptor corresponding to such an address in address location 72(1) and register 74 stores a context description associated with the current job descriptor. If an address is currently being stored in address location 72(2) of FIFO queue 71, then register 75 stores a job descriptor corresponding to such an address in address location 72(2) and register 76 stores a context description associated with the prefetched job descriptor. Alternatively, if the address in address location 72(1) points to a job descriptor indicating it is part of a chain of job descriptors and there is at least one more unexecuted job descriptor remaining in the chain, then register 75 stores the next job descriptor in the chain and register 76 stores a context description associated with the next job descriptor in the chain

Those having ordinary skill in the art will appreciate that registers 74 and 76 are primarily needed to facilitate a dynamic swapping between job descriptors where one or more job descriptors are swapped out prior to being executed by unit 60.

In practice, the textual configuration of a job descriptor and the structural configuration of registers 73-76 will be dependent upon the specification of an adapter card upon which formatter 50 will be installed. Thus, one having ordinary skill in the art will appreciate that the variety of the textual configuration of a job descriptor and the variety of structural configuration of registers 73-76 are essentially limitless.

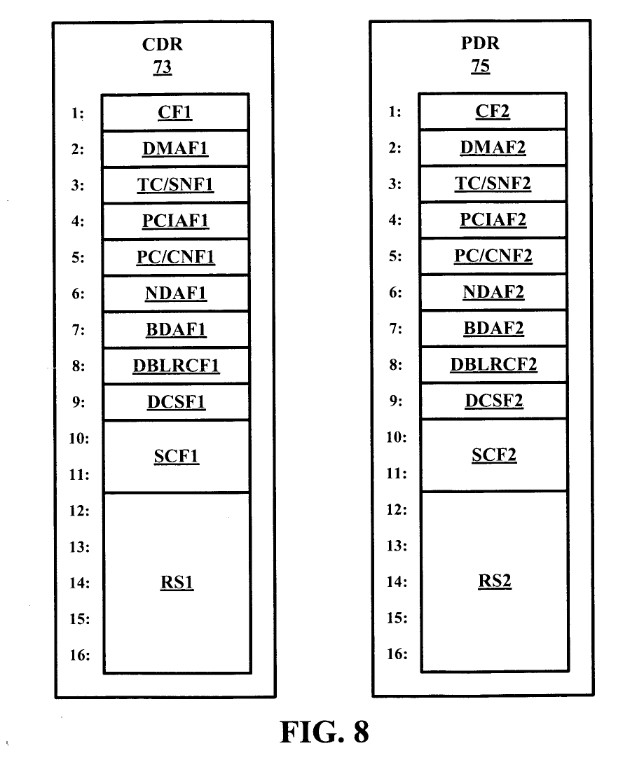

In one exemplary embodiment, as illustrated in FIG. 8, registers 73 and 75 hold up to sixteen (16) words of the current job descriptor and the prefetched job descriptor, respectively. The first words are control fields CF1 and CF2, respectively, for indicating whether the DASD formatting scheme or the Tape formatting scheme should be implemented during a corresponding data transfer. The second words are data memory address fields DMAF1 and DMAF2, respectively, for indicating a beginning address within an external memory of the data to be transferred. The third words are transfer count/sequence number fields TCSNF1 and TCSNF2, respectively, for indicating a total number of bytes to be transferred and a starting sequence number. The forth words are PCI address fields PCIAF1 and PCIAF2, respectively, for indicating a beginning adapter PCI address from which the data is stored to or fetched from. The fifth words are PCI count/context number fields PC/CNF1 and PC/CNF2, respectively, for indicating a number of bytes to be transferred on an adapter PCI interface and the context of the current operation.

The sixth words are next descriptor address fields NDAF1 and NDAF2, respectively, for indicating an address in an external memory of the next job descriptor that is chained to the current job descriptor. The seventh words are branch descriptor address fields BDAF1 and BDAF2, respectively, for indicating point to a next descriptor on an expanding compression of the data. The eighth words are descriptor block LRC fields DBLRCF1 and DBLRCF2, respectively, for indicating a LRC for words 1-7. The ninth words are descriptor completion status fields DCSF1 and DCSF2, respectively, for indicating a completion of an operation without any check condition. The tenth and eleventh words are store count fields SCF1 and SCF2, respectively, for selectively storing interfaced data. Words 12-16 are reserved.

FIG. 9 illustrate an exemplary embodiment of descriptor queue 70 employing current job descriptor register 73, current context register 74, three (3) prefetched job descriptor registers 75, and three (3) prefetched context registers 76. This embodiment is suited for direct storage of job descriptors within descriptor queue 70.

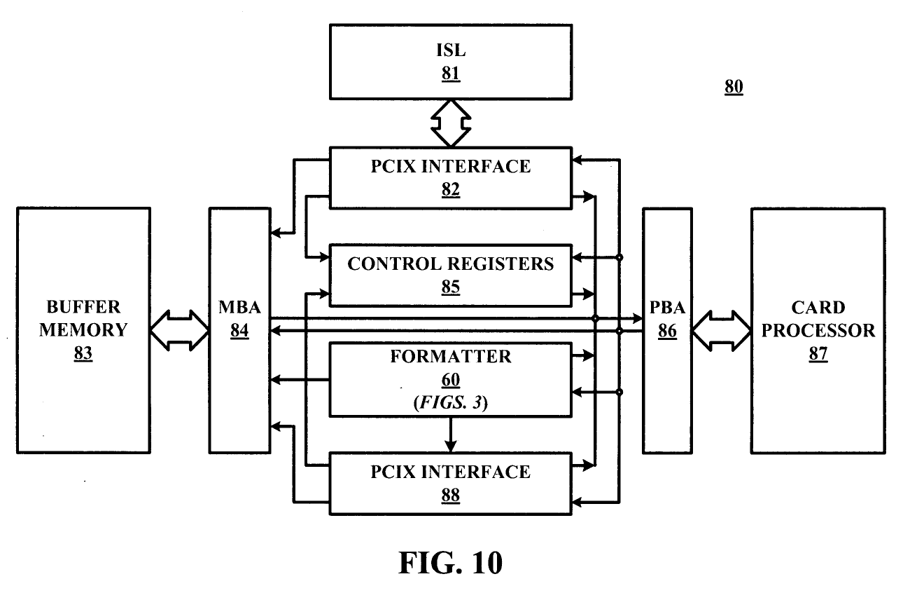

FIG. 10 illustrates an adapted card 80 employing a configuration of formatter 60, an interface specific logic (“ISL”) 81, a PCIX interface 82, a buffer memory 83, a memory buffer adapter 84, one or more control registers 85, a processor buffer adapter 86, a card processor 87, and a PCIX interface 83. This structural configuration of adapter card 80 facilitates an execution of data read cycles and data write cycles based on job descriptors generated by processor 87.

Specifically, as illustrated in FIG. 10, a computer system 20 issues a data write command DWC to ISL 81, which informs processor 87 of data write command DWC and stores the data DDWC1 associated with data write command DWC into buffer memory 83. Processor 87 generates job descriptor JD_{DWC} to indicate a data formatting scheme for data D_{DWC1} and stores job descriptor JD_{DWC} in buffer memory 83 while communicating an address pointer JDA_{DWC} to formatter 60. At the appropriate time, formatter 60 will retrieve job descriptor JD_{DWC} as stored in buffer memory 83 based on address pointer JDA_{DWC}. Alternatively, processor 87 can directly communicate job descriptor JD_{DWC} to formatter 60 as indicated by the dashed arrow.

Upon initiation an execution of job descriptor JD_{DWC}, formatter 60 retrieves data D_{DWC1} from buffer memory 83 as pointed out by job descriptor JD_{DWC} and thereafter formats data D_{DWC1} in accordance with the data formatting scheme indicated by job descriptor JD_{DWC} to thereby render formatted data D_{DWC2} that is stored within an appropriate storage device 27 (e.g., a disk drive or a tape drive).

As illustrated in FIG. 12, a computer system 20 issues a data read command DRC to ISL 81, which informs processor 87 of data read command DRC. Processor 87 generates job descriptor JD_{DRC} to indicate a data formatting scheme for a data D_{DRC1} stored with corresponding storage device 27 and stores job descriptor JD_{DRC} in buffer memory 83 while communicating an address pointer JDA_{DRC} to formatter 60. At the appropriate time, formatter 60 will retrieve job descriptor JD_{DRC} as stored in buffer memory 83 based on address pointer JDA_{DRC}. Alternatively, processor 87 can directly communicate job descriptor JD_{DRC} to formatter 60 as indicated by the dashed arrow.

Upon initiation an execution of job descriptor JD_{DRC}, formatter 60 retrieves data D_{DRC1} from storage device 27 as pointed out by job descriptor JD_{DRC} and thereafter formats data D_{DRC1} in accordance with the data formatting scheme indicated by job descriptor JD_{DRC} to thereby render formatted data D_{DRC2} that is eventually transferred to computer system 20 via buffer memory 83 and/or ISL 81.

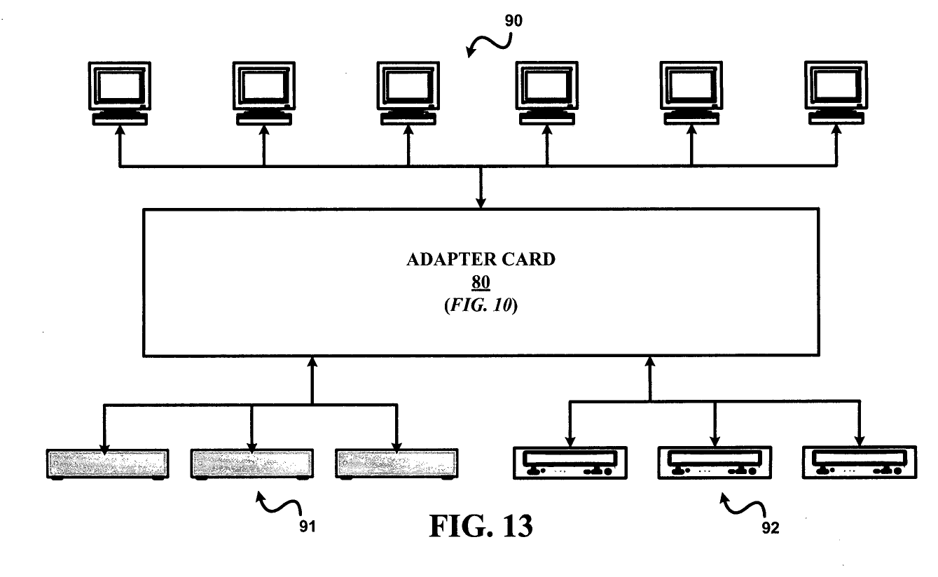

From the preceding descriptions of FIGS. 3-12, those having ordinary skill in the art will appreciate the numerous advantage of the present invention, such as, for example, an incorporation of adapter card 80 within a computing and storing system as illustrated in FIG. 13. The system includes a network 90 of host computers coupled to ISL 81 (FIG. 10) of adapter card 80, a network 92 of disk drives coupled to interface 88 (FIG. 10) of adapter card 80, and a network 93 of tape drives coupled to interface 88 of adapter card 80. Adapter card 80 provides an on-demand allocation and partitioning of resources to enable a selective implementation of a DASD formatting scheme for data transfers between network 90 and network 91, and a selective implementation of a Tape formatting scheme for data transfers between network 90 and network 92.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

I claim:

1. An adapter card for formatting data transfers between at least two network devices, the adapter card comprising:
a multi-formatting execution unit operable to format each data transfer between the at least two network devices based on one of a plurality of data formatting schemes, each data formatting scheme being at least partially dissimilar from the other data formatting schemes;
at least one descriptor queue, each descriptor queue being operable to store at least one job descriptor, each job descriptor being indicative of a selection of one of the plurality of data formatting schemes for formatting a corresponding data transfer between the at least two network devices; and
at least one communication channel operable to selectively connect the at least one descriptor queue to the multi-formatting execution unit to facilitate each electrical communication of each one job descriptor from the at least one descriptor queue to the multi-formatting execution unit.

2. The adapter card of claim 1,
wherein a first data formatting scheme among the plurality of data formatting schemes is a direct access storage device formatting scheme; and
wherein a second data formatting scheme among the plurality of data formatting schemes is a tape formatting scheme.

3. The adapter card of claim 1, wherein the multi-formatting execution unit includes:
a queue controller operable to control each electrical communication between the multi-formatting execution unit and the at least one descriptor queue as a function of a queue swapping policy representative of a selective queue swapping among at least two descriptor queues.

4. The adapter card of claim 1, wherein the multi-formatting execution unit is operable to format a first data transfer between the at least two network devices based on a first data formatting scheme among the plurality of data formatting schemes in response to a first electrical communication of a first job descriptor from one of the at least one descriptor queue through one of the at least one communication channel, the first job descriptor being indicative of the formatting of the first data transfer between the at least two network devices based on the first data formatting scheme.

5. The adapter card of claim 4,
wherein the at least one communication channel includes a first communication channel operable to connect a first descriptor queue to the multi-formatting execution unit while the remaining communication channels are disconnected from the multi-formatting execution unit to facilitate the first electrical communication of the first job descriptor from the first descriptor queue through the first communication channel to the multi-formatting execution unit.

6. The adapter card of claim 4, wherein the multi-formatting execution unit is operable to format a second data transfer between the at least two network devices based on a second data formatting scheme among the plurality of data formatting schemes in response to a second electrical communication of a second job descriptor from one of the at least one descriptor queue through one of the at least one communication channel, the second job descriptor being indicative of the formatting of the second data transfer between the at least two network devices based on the second data formatting scheme.

7. The adapter card of claim 6,
wherein the at least one communication channel includes a first communication channel operable to connected a first descriptor queue to the multi-formatting execution unit while the remaining communication channels are disconnected from the multi-formatting execution unit to facilitate the first electrical communication of the first job descriptor from the first descriptor queue through the first communication channel to the multi-formatting execution unit; and
wherein the at least one communication channel further includes a second communication channel operable to connect a second descriptor queue to the multi-formatting execution unit while the remaining communication channels are disconnected from the multi-formatting execution unit to facilitate the first electrical communication of the first job descriptor from the second descriptor queue through the first communication channel to the multi-formatting execution unit.

8. The adapter card of claim 1, further comprising:
at least one card processor; and
at least one buffer memory coupled to the at least one processor, wherein the at least one buffer memory stores instructions operable with the at least one card processor to perform operations including:
generating the at least one job descriptor in response to an electrical communication of at least one data transfer command from the at least two network devices, each data transfer command requesting a particular data transfer between the at least two network devices based on one of the plurality of data formatting schemes;
managing a storage of at least one of the at least one job descriptor in the at least one card buffer memory; and
managing a storage of an address pointer in the at least one descriptor queue for each job descriptor stored in the at least one card buffer memory.

9. The adapter card of claim 1, further comprising:
at least one card processor; and
at least one buffer memory coupled to the at least one processor, wherein the at least one buffer memory stores instructions operable with the at least one card processor to perform operations including:
generating the at least one job descriptor in response to an electrical communication of at least one data transfer command from the at least two network devices, each data transfer command requesting a particular data transfer between the at least two network devices based on one of the plurality of data formatting schemes; and
managing a storage of at least one of the at least one job descriptor in the at least one descriptor queue.

10. An adapter card, comprising:
a formatter operable to format each data transfer between at least two network devices as a function of at least one job descriptor, each job descriptor being indicative of a selection of one of the plurality of data formatting schemes for formatting a corresponding data transfer between the at least two network devices, each data formatting scheme being at least partially dissimilar from the other data formatting schemes;
at least one card processor; and
at least one buffer memory coupled to the at least one processor, wherein the at least one buffer memory stores instructions operable with the at least one card processor to perform operations including:
generating the at least one job descriptor in response to an electrical communication of at least one data transfer command from the at least two network devices, each data transfer command requesting a particular data transfer between the at least two network devices based on one of the plurality of data formatting schemes;
managing a storage of at least one of the at least one job descriptor in the at least one card buffer memory, and
managing a storage of an address pointer in the formatter for each job descriptor stored in the at least one card buffer memory.

11. The adapter card of claim 10,
wherein a first data formatting scheme among the plurality of data formatting schemes is a direct access storage device formatting scheme; and
wherein a second data formatting scheme among the plurality of data formatting schemes is a tape formatting scheme.

12. The adapter card of claim 10, wherein the formatter includes:
a multi-formatting execution unit operable to execute each job descriptor;
at least one descriptor queue, each descriptor queue being operable to store the at least one job descriptor, and
at least one communication channel operable to selectively connect the at least one descriptor queue to the multi-formatting execution unit to facilitate each electrical communication of each job descriptor from the at least one descriptor queue to the multi-formatting execution unit.

13. The adapter card of claim 12, wherein the multi-formatting execution unit includes:
a queue controller operable to control each electrical communication between the multi-formatting execution unit and the at least one descriptor queue as a function of a queue swapping policy representative of a selective queue swapping among at least two descriptor queues.

14. The adapter card of claim 12, wherein the multi-formatting execution unit is operable to format a first data transfer between the at least two network devices based on a first data formatting scheme among the plurality of data formatting schemes in response to a first electrical communication of a first job descriptor from one of the at least one descriptor queue through one of the at least one communication channel, the first job descriptor being indicative of the formatting of the first data transfer between the at least two network devices based on the first data formatting scheme.

15. The adapter card of claim 14,
wherein the at least one communication channel includes a first communication channel operable to connect a first descriptor queue to the multi-formatting execution unit while the remaining communication channels are disconnected from the multi-formatting execution unit to facilitate the first electrical communication of the first job descriptor from the first descriptor queue through the first communication channel to the multi-formatting execution unit.

16. The adapter card of claim 14, wherein the multi-formatting execution unit is operable to format a second data transfer between the at least two network devices based on a second data formatting scheme among the plurality of data formatting schemes in response to a second electrical communication of a second job descriptor from one of the at least one descriptor queue through one of the at least one communication channel, the second job descriptor being indicative of the formatting of the second data transfer between the at least two network devices based on the second data formatting scheme.

17. The adapter card of claim 16,
wherein the at least one communication channel includes a first communication channel operable to connected a first descriptor queue to the multi-formatting execution unit while the remaining communication channels are disconnected from the multi-formatting execution unit to facilitate the first electrical communication of the first job descriptor from the first descriptor queue through the first communication channel to the multi-formatting execution unit; and
wherein the at least one communication channel further includes a second communication channel operable to connect a second descriptor queue to the multi-formatting execution unit while the remaining communication channels are disconnected from the multi-formatting execution unit to facilitate the first electrical communication of the first job descriptor from the second descriptor queue through the first communication channel to the multi-formatting execution unit.

18. An adapter card, comprising:
a formatter operable to format each data transfer between at least two network devices as a function of at least one job descriptor, each job descriptor being indicative of a selection of one of the plurality of data formatting schemes for formatting a corresponding data transfer between the at least two network devices, each data formatting scheme being at least partially dissimilar from the other data formatting schemes;
at least one card processor
at least one buffer memory coupled to the at least one processor, wherein the at least one buffer memory stores instructions operable with the at least one card processor to perform operations including:
generating the at least one job descriptor in response to an electrical communication of at least one data transfer command from the at least two network devices, each data transfer command requesting a particular data transfer between the at least two network devices based on one of the plurality of data formatting schemes;
managing a storage of at least one of the at least one job descriptor in the at least one card buffer memory, and
managing a storage of an address pointer in the formatter for each job descriptor stored in the at least one card buffer memory.

19. The adapter card of claim 18,
wherein a first data formatting scheme among the plurality of data formatting schemes is a direct access storage device formatting scheme; and
wherein a second data formatting scheme among the plurality of data formatting schemes is a tape formatting scheme.

20. The adapter card of claim 18, wherein the formatter includes:
a multi-formatting execution unit operable to execute each job descriptor;
at least one descriptor queue, each descriptor queue being operable to store the at least one job descriptor, and
at least one communication channel operable to selectively connect the at least one descriptor queue to the multi-formatting execution unit to facilitate each electrical communication of each job descriptor from the at least one descriptor queue to the multi-formatting execution unit.

21. The adapter card of claim 20, wherein the multi-formatting execution unit includes:
a queue controller operable to control each electrical communication between the multi-formatting execution unit and the at least one descriptor queue as a function of a queue swapping policy representative of a selective queue swapping among at least two descriptor queues.

22. The adapter card of claim 20, wherein the multi-formatting execution unit is operable to format a first data transfer between the at least two network devices based on a first data formatting scheme among the plurality of data formatting schemes in response to a first electrical communication of a first job descriptor from one of the at least one descriptor queue through one of the at least one communication channel, the first job descriptor being indicative of the formatting of the first data transfer between the at least two network devices based on the first data formatting scheme.

23. The adapter card of claim 22,
wherein the at least one communication channel includes a first communication channel operable to connect a first descriptor queue to the multi-formatting execution unit while the remaining communication channels are disconnected from the multi-formatting execution unit to facilitate the first electrical communication of the first job descriptor from the first descriptor queue through the first communication channel to the multi-formatting execution unit.

24. The adapter card of claim 22, wherein the multi-formatting execution unit is operable to format a second data transfer between the at least two network devices based on a second data formatting scheme among the plurality of data formatting schemes in response to a second electrical communication of a second job descriptor from one of the at least one descriptor queue through one of the at least one communication channel, the second job descriptor being indicative of the formatting of the second data transfer between the at least two network devices based on the second data formatting scheme.

25. The adapter card of claim 24,
wherein the at least one communication channel includes a first communication channel operable to connected a first descriptor queue to the multi-formatting execution unit while the remaining communication channels are disconnected from the multi-formatting execution unit to facilitate the first electrical communication of the first job descriptor from the first descriptor queue through the first communication channel to the multi-formatting execution unit; and
wherein the at least one communication channel further includes a second communication channel operable to connect a second descriptor queue to the multi-formatting execution unit while the remaining communication channels are disconnected from the multi-formatting execution unit to facilitate the first electrical communication of the first job descriptor from the second descriptor queue through the first communication channel to the multi-formatting execution unit.

26. A signal bearing medium tangibly embodying a program of machine-readable instructions executable by at lease one processor to perform operations to format data transfers between at least two network devices, the operations comprising:
generating a job descriptor for each data transfer between the at least two network device, each job descriptor being indicative of a selection of one of a plurality of data formatting schemes for formatting a corresponding data transfer between the at least two network devices, each data formatting scheme being at least partially dissimilar from the other data formatting schemes; and
formatting each data transfer between the at least two network devices based on a corresponding job descriptor.

27. The signal bearing medium of claim 26,
wherein a first data formatting scheme among the plurality of data formatting schemes is a direct access storage device formatting scheme; and
wherein a second data formatting scheme among the plurality of data formatting schemes is a tape formatting scheme.
